(19) United States
(12) Patent Application Publication
(10) Pub. No.: US 2010/0092622 A1
(43) Pub. Date: Apr. 15, 2010

(54) Varieties of bold, "Tart and Cool", Sweet and Sour", or "Sharp and Spicy" beverage drinks

(76) Inventor: Roy Dean Warner, Ft. Collins, CO (US)

Correspondence Address: Roy Dean Warner, 5137 Arrowhead Lane, Ft. Collins, CO, 80526, US

(21) Appl. No.: 12/249,930

(22) Filed: Oct. 12, 2008

(51) Int. Cl. A23L 2/56; A23L 2/72; B65D 85/72

(52) U.S. Cl. 426/115; 426/599; 426/397

(57) ABSTRACT

This invention is a broad new variety of delicious beverage drinks. Consisting of 2% or above concentration of apple cider vinegar, red or rice wine vinegar, distilled white or any other vinegar or vinegar product. Water, sea salt or any other salt, sugar and/or any other natural or artificial sweeteners. Fresh whole vegetables, fruits, peppers and spices, organically or otherwise grown. In singular vegetable, fruit, spice or pepper flavors or any combinations thereof. Flavor mixtures strained and filtered to a crystal clear liquid, like water or strained leaving a measured amount of pulp, pepper seeds and spice particles. Some flavors with a small fresh pepper or fruit in the bottle. All delicious flavors conveniently available in 6, 8, 12 ounce or larger containers.

New varieties of bold, “tart and cool”, “sweet and sour” or “sharp and spicy”, beverage drinks. 2% or above apple cider vinegar, red or rice wine vinegar, distilled white or any other vinegar, or vinegar product. Water, sea salt or any other salt, sugar, other natural or artificial sweeteners. In flavors of spices, vegetables, peppers, or fruit ingredients, or any combinations thereof, to produce a broad range of delicious flavors.

### DESCRIPTION

This vinegar based beverage drink product incorporates flavoring ingredients, organically grown or otherwise, of any and all fresh, whole, vegetables, fruits, and peppers that have been reduced to pulp, and/or juices with or without pulp, and ground, powdered or any form of spices. And/or use of artificial sweeteners, and natural flavors, the essential oils, oleoresins, essence's, extractives, distillates, or any products which contain the flavoring constituents derived from a spice, fruit or fruit juice, vegetable or vegetable juice with the significant function of flavoring, in singular flavors, or all combinations thereof, to produce a large variety of specific flavors. Some flavors with a small fresh pepper or fruit in the bottle for novelty and appeal. Conveniently bottled in 6, 8, 12 ounce or larger containers.

Some varieties of this beverage are strained and filtered to a crystal clear liquid, like water, others have a measured amount or pulp, pepper seeds, spice particles and a small fresh whole pepper or fruit settled on the bottom of the bottle for novelty and appeal.

Flavor ingredients will be added to a “MILD”, “MEDIUM”, or “SHARP” basic stock recipe, which consists of variations of proportions of any and all types of vinegar or vinegar powders, of 2% vinegar concentration or above, fresh clean water, any and all varieties of salts, sugars, natural or artificial sweeteners.

A variety of “MILD” apple cider or red wine vinegar concentration, lightly salted, primarily sweet and sour fruity and/or spicy beverages. Flavored with tangerine, mandarin orange, mango, apple, lemon, lime, watermelon, cantelope, pineapple, cherry, apricot, kumquat, plum, any berries or other fruit flavors.

In singular sweet, spicy and sour fruit flavors or combinations thereof with any vegetables, peppers and spices, with or without pulp, pepper seeds and spice particles. Some flavors will have a small fresh whole pitted cherry, plum, apricot, kumquat, or slice or wedge of the fruit, representative of the flavor, in the bottle for appeal and novelty.

A variety of “MEDIUM” red wine or apple cider vinegar concentration, mildy salted, primarily tart, spicy and/or fruity vegetable beverages. Flavored with cucumber, pumpkin, tomato, celery, or any other vegetable flavors. In singular, tart and cool, vegetable flavors, or combinations thereof with any fruit, peppers or spices, with or without pulp, pepper seeds and spice particles.

Also a variety of “SHARP” red wine or distilled white vinegar and salty concentration, primarily “biting hot and spicy” beverages. Flavored with, jalapeno, habanera, red or chipotle chili, cayenne, bell peppers, garlic, szechuan pepper, peppercorns, mustard seeds, dill weed, curry salt, bourbon pepper, brandied pepper, Worcestershire salts and any other spices and/or peppers. In singular pepper and/or spice flavors and combinations thereof with any fresh whole pulped vegetables, fruits, peppers or vegetable, fruit and pepper juices,

With or without pulp, pepper seeds and spice particles. Some flavors will have a small fresh whole jalapeno, habanera, red chili pepper, garlic clove, caper, or any other spice representative of the flavor, in the bottle for appeal and novelty.

Beverage flavors will have distinctive names, container labels, and vibrant or electric colorations descriptive of the contents.

Mixture flavors will then be bottled, canned or otherwise contained using standard sterile bottling or canning procedures, in convenient 6, 8, 12 oz. or larger bottles, cans, or containers.

Best served cold, and kept refrigerated after opening.

Recommended standard “Basic stock” recipe preparation examples:

This product makes use of the below example recipes, any recipe or ingredient variations thereof, and any and all other known production methods.

The following examples list recommended proportions for the standard “MILD”, “MEDIUM” and “SHARP” variations of vinegar and salty flavors.

In the production of this beverage drink, it is recommended for best flavor results, although variable, that Sea Salt be used for all flavors, that apple cider vinegar be used with all fruity flavors, red wine or apple cider vinegar used with all vegetable flavors, and red wine or distilled white vinegar with all pepper and/or spice flavors. White refined sugars may be replaced by brown ‘muscovado’ sugar or molasses.

Using a 2½ or 3 gal. pot to produce 1 gallon; Mix the following proportions of recipe ‘A’, ‘B’ or ‘C’ below.

A. “Sharp vinegar and salt flavor”; (50% vinegar concentration).
2 quarts water.
2 quarts red wine, distilled white, or any other vinegar.
½ cup (8 fluid oz.) sea salt, iodized, kosher, or any other salt.

B. “Medium vinegar and mild salty flavor”; (25% vinegar concentration).
3 quarts water.
1 quart red wine or apple cider vinegar, white distilled, or any other vinegar.
¼ cup (4 fluid oz.) sea salt, iodized, kosher, or any other salt.

C. “Mild vinegar and light salty flavor”; (approx. 100% vinegar concentration).
3½ quarts water.
1 pint apple cider vinegar or any other vinegar.
⅛ cup (2 fluid oz.) sea salt, iodized, kosher, or any other salt.

Using one of the above “basic stock recipes”, add one of the following specific flavor ingredient recipes to obtain desired flavors. This preparation makes use of the below example recipes, any variations of procedures or ingredients thereof, and/or any other known methods.

(a) For vegetable only flavors,
Add 2 quarts of selected fresh vegetable pulp to the “basic stock” mild, medium or sharp recipe.

(b) For spicy, vegetable flavors,
Add 2 quarts selected fresh vegetable pulp.
1 cup selected fresh spice(s) pulp.
½ cup ground dried selected spices and/or peppers, with or without seeds, salts or powders.
Add to the mild, medium or sharp “basic stock” recipe.

(c) For fruity, “sweet and sour” flavors, add 2 quarts of selected fresh fruit pulp.
1 cup sugar.
Add to the mild or medium “basic stock” recipe.

(d) For spicy, fruit flavors, “spicy sweet and sour”, add 2 quarts selected fresh fruit pulp.
1 cup sugar.
1 cup selected fresh spice(s) pulp.
½ cup ground selected dried spices and/or peppers, with or without seeds, salts or powders.
Add to the mild, medium or sharp “basic stock” recipe.

(e) For “biting hot and spicy” flavors,
Add 1 cup of selected fresh spice pulp.
½ cup selected ground dried spice and/or peppers, with or without seeds, spice salts or powders.
Add to the medium or sharp “basic stock” recipe.

For enhanced sweetness add 1 ounce of artificial sweetener to any sweet recipe.

For enhanced flavor add 1 ounce of selected natural flavor, the essential oils, oleoresins, essence, extractive, powders, distillates, or any product which contains the flavoring constituents derived from a spice, fruit or fruit juice, vegetable or vegetable juice with the significant function of flavoring, to any of the recipes.

(3a) if using ‘only’ fresh, whole, prepared, vegetables, fruits, peppers and spices. *(see ‘solid ingredient’ preparation method below).

Heat mixture to boiling, and then slow boil while stirring for up to 10 minutes or until ingredients are reduced to a pulpy mash. Remove from heat.

(3b) If using ‘only’ vegetable or fruit juices, with or without pulp, ground or powdered peppers, spice salts, oils, extracts thereof, and other natural flavors, the essential oils, oleoresins, essence's, extractives, distillates, or any products which contain the flavoring constituents derived from a spice, fruit or fruit juice, vegetable or vegetable juice with the significant function of flavoring.

Heat mixture to boiling until all salts, are dissolved. Remove from heat.

(4) Stir in 1 oz. liquid or 1 teaspoon gel or powder, of any FDA approved food coloring, descriptive of the specific product flavor. ** (color examples noted below).

(5) Under sterile conditions, strain and filter to a crystal clear liquid, like water. Or, for product with desired pulp, coarsely strain leaving up to ½ quart per gallon, or more, pulp, pepper seeds, and spice particles.

(For selected “Hot & Spicy” or “Fruity” beverage's, prepare for insertion into the pre-sterilized bottle a small fresh, whole jalapeno, habanera, red chili, garlic clove, any other pepper, or fresh whole cherry, apricot, plum, kumquat, berry, or any small fruit, by removing stems or pits, wash and sterilize, with 10 second dip in boiling water.)

(6) Product will then be bottled, canned or otherwise contained using standard sterile bottling or canning procedures, in convenient 6, 8, or 12 oz. bottles, cans or larger containers.

* Solid ingredient preparation of fresh whole vegetables, fruits, peppers and spices, for boiling with 1 gallon “basic stock recipe”.

This preparation makes use of the below ingredient preparation procedures, any variations of procedures or ingredients thereof, and any other known methods.

For vegetable and/or vegetable pepper and spice flavors, prepare enough of the selected solid fresh vegetable, i.e. cucumbers, tomatoes, celery, pumpkin, or any vegetable, removing any stems, cleaning out seeds, washing, peeling, dicing and mashing or blending to a pulp.

Fill a 2 quart container with the pulp.

For fruit and/or fruit and spice flavors prepare enough selected solid fresh fruits, i.e. mandarin oranges, mangos, tangerines, apples, lemons, limes, apples, plums, cherries, berries and any other fruit, by removing any stems and pits, washing, zesting oranges, tangerines, lemons, limes, key limes and other citrus fruits for zest additive, peeling when needed, juicing and blending to a pulp.

Fill a 2 quart container with all juice, zest and pulp.

Prepare enough fresh whole peppers, i.e., jalapeños, habaneras, chili peppers, red, green, yellow peppers or any other pepper by removing stems, washing, clean out seeds, (save seeds for use in biting hot spicy flavors) slice, dice and mash or blend the meat of the peppers to a pulp.

Fill 1 cup with pulp. Add the seeds for extra spicy flavor.

Crush, grind, or blend, coarse or fine, any and all types of selected solid dried peppers, peppercorns, dill weed, garlic, celery seed, basil, mustard seed, lemon grass, grape leaves or any other spices.

Fill ½ cup.

Example flavors, and example distinctive flavor names;
“Jalapeno Dill”
“Tomato Jalapeno Dill”
“Habanera Dill”
“Tomato Habanera Dill”
“Red chili Dill”
“Tomato Red Chili Dill”
“Tomato Szechuan”
“Garlic blast”
“Tomato Garlic Dill”
“Cool Cumber Dill”
“Sour Tomato Cayenne”
“Sour Lemon Dill”
“Sour Lime Dill”
“Sweet and Sour Key lime”
“Sweet and spicy key lime”
“Sweet and Sour Tangerine”
“Sweet and spicy Tangerine”
“Sweet and Sour Orange”
“Sweet and spicy Orange”
“Sour Green Apple”
“Sweet and spicy Apple”
“Sweet and sour Mango”
“Sweet and spicy Mango”
“Sweet and Sour Cantaloupe”
“Sweet and spicy Cantaloupe”
“Sweet and Sour Pineapple”
“Sweet and spicy Pineapple”
“Sweet and Sour Cherry”
“Sweet and spicy Cherry”
“Sweet and Sour Raspberry”
“Sweet and spicy Raspberry”
“Sweet and Sour Blackberry”
“Sweet and spicy Blackberry”
“Sweet and Sour Blueberry”
“Sweet and spicy Blueberry”

** Vibrant or electric food colorings added to enhance appeal, and descriptive of the beverage content, examples;
“Electric lime green jalapeno dill”
“Electric orange habanera dill”
“Electric red chili dill”
“Cool cucumber emerald green”
“Sweet and sour plain orange”
“Granny apple green”
“Royal blueberry”

The unique quality of this new product captures the flavors that people crave which compels them to eat pickles, pickled vegetables, spicy hot sauces, spiced fruits and those flavors are now conveniently available in a cold, clear, or ‘hearty’ liquid beverage drink.

With many new and delicious sweet and sour or spicy sweet and fruity flavors, tart and sour or tart and spicy vegetable drinks and explosive hot pepper and spicy or spicy, hot pepper and vegetable flavors. Conveniently available in 6, 8, 12 oz. bottles or cans and larger containers.

Some of the various flavors of this new drink may be similar in taste, but not use, to such products as;
Vinegar and dill based pickling juice for cucumbers.
The juice used to pickle olives and other vegetables.
Vinegar based fruit pickling juices.
Vinegar based hot sauces and marinades.

Vinegar lends its mild, medium or sharp taste to any and all vegetable, pepper, spice, and fruity flavors of these new beverage drinks.

None of which are too sweet.
All non alcoholic.
Not carbonated.
Not a sticky soda pop.
Not just another ordinary vegetable juice.
Not another fruit juice.
Not another sweetened fruity tasting water.

Selected flavors will have a small fresh whole pepper, or fruit in the bottle for purposes of novelty and appeal. With vibrant and electric eye catching food color additives. All delicious flavors conveniently available in 6, 8, 12 oz. distinctively labeled bottles, cans or larger containers. May includes vitamin and mineral additives that will fortify and replenish vitamins and minerals lost during preparation, such as ascorbic acid, citric acid. And additional salt enhancements as sodium alginate, calcium chloride, flavor stabilizers, potassium sorbet, polysorbates or any other required additives for flavor retention and product preservation.

What is claimed is:

1. This product is an innovative, novel, stimulating and refreshing new variety of boldly delicious, “tart and cool”, “sweet and sour” or “sharp and spicy”, palate cleansing new beverage drinks. New varieties of specific flavors of vegetables, spices, fruits, peppers and any and all combinations thereof with a mild, medium or sharp vinegar taste. Brilliantly delivered in “Electric” and vibrant colors descriptive of the flavor content. A drink, that is thirst quenching, cold, tart and as clear as water with a mild salty flavor of cucumbers and dill or a “hearty” cold and delicious drink, pulpy with vegetables or fruits, and bits of spices, peppers and seeds to chew on. A cold, sweet and sour drink with the fragrance and sweet taste of apricots, or any fruit, but mildly sour like a liquor or a cold, clear, but spicy hot, sweet and sour vegetable or fruit flavor and a cold, clear, or pulpy, spicy hot and sour drink with flavors of tomatoes and cayenne, or jalapeno, habanera or szechuan pepper, that will bite your tongue and make you sweat.

2. Product mixtures will be strained and filtered producing a crystal clear non-viscous liquid like water or partially strained to a measured degree to provide a “hearty” drink with a desired amount of vegetable, or fruit or pepper pulp, seeds and spice particles and combinations thereof, suspended throughout the drink, and settled on the bottom of the bottle. Some “biting hot and spicy” flavors will have one small, fresh, whole green jalapeno, habanera, garlic clove, red chili pepper or any other spice or pepper which is descriptive of the contents, inserted into the bottle where it will settle on the bottom, providing novelty and appeal. Some fruit and fruit and vegetable flavors will have a small fresh whole (pitted) cherry, plum, kumquat, berry, or any small fruit, descriptive of the contents, inserted into the bottle where it will settle on the bottom, providing novelty and appeal.

3. All delicious flavors conveniently available in 6, 8, 12 oz. distinctively labeled bottles, cans or larger containers.
